(19) United States
(12) Patent Application Publication
(10) Pub. No.: US 2024/0326559 A1
(43) Pub. Date: Oct. 3, 2024

(54) HEATER,TRANSPORT REFRIGERATION UNIT AND SYSTEM

(71) Applicant: Carrier Corporation, Palm Beach Gardens, FL (US)

(72) Inventors: Zheng He, Shanghai (CN); Fei Xie, Shanghai (CN); Hai Tian, Shanghai (CN)

(21) Appl. No.: 18/617,237

(22) Filed: Mar. 26, 2024

(30) Foreign Application Priority Data
Mar. 27, 2023 (CN) 202310308794.7

(51) Int. Cl. B60H 1/22; B60H 1/00

(52) U.S. Cl. CPC B60H 1/2218; B60H 1/00735; B60H 2001/2275

(57) ABSTRACT

The present application relates to a heater, the heater comprising: a first heating resistor, the first heating resistor being a thermistor; a second protective resistor connected in series with the first heating resistor, wherein the second protective resistor has a constant resistance value; and a temperature switch connected in parallel with the second protective resistor, wherein the temperature switch enables or bypasses the second protective resistor according to surface temperature of the first heating resistor. The present application also relates to a transport refrigeration unit, a refrigeration system for a transport unit, and a method of controlling a heater in a transport refrigeration unit TRU.

### CROSS REFERENCE TO RELATED APPLICATIONS

This application claims priority to Chinese Patent Application No. 202310308794.7 filed on Mar. 27, 2023, which is incorporated by reference herein in its entirety.

### TECHNICAL FIELD

The present application relates to a field of heating control and, more specifically, to a heater, a transport refrigeration unit, a refrigeration system for a transport unit, and a method of controlling a heater in a transport refrigeration unit TRU.

### BACKGROUND

For electric transport refrigeration units, in order to effectively control surface temperature of a heater and avoid safety hazards such as scald, fire and so on, the existing scheme uses a heater of positive temperature coefficient (PTC) material (that is, PTC heater). Specifically, the PTC heater's resistance is generally proportional to the temperature, and the temperature will not exceed curie point temperature (about 200 degrees), which can effectively avoid the risk of high temperature.

FIG. 2 shows a schematic diagram of the resistance-temperature characteristic of the PTC heater. As shown in FIG. 2, when the surface temperature of the PTC heater is low (as shown by 210), its resistance value is small, and an impulse current generated by cold starting the PTC heater may exceed the maximum current allowed by the transport refrigeration unit TRU. In other words, the impulse current generated during cold start of the PTC heater may adversely affect the transport refrigeration unit TRU.

### SUMMARY

According to an aspect of the present application, there is provided a heater, the heater comprising: a first heating resistor, the first heating resistor being a thermistor; a second protective resistor connected in series with the first heating resistor, wherein the second protective resistor has a constant resistance value; and a temperature switch connected in parallel with the second protective resistor, wherein the temperature switch enables or bypasses the second protective resistor according to surface temperature of the first heating resistor.

As a supplement or replacement of the foregoing, in the heater, the first heating resistor is a positive temperature coefficient PTC resistor.

As a supplement or replacement of the foregoing, in the heater, the temperature switch comprises: a temperature probe for sensing the surface temperature of the first heating resistor; and a switching unit for keeping the temperature switch open when the surface temperature of the first heating resistor is lower than a preset temperature threshold, and causing the temperature switch to close when the surface temperature of the first heating resistor is greater than or equal to the preset temperature threshold.

As a supplement or replacement of the foregoing, in the heater, the preset temperature threshold is determined according to a resistance-temperature characteristic of the first heating resistor.

According to another aspect of the present application, there is provided a transport refrigeration unit TRU, the transport refrigeration unit TRU comprising the heater as previously described.

As a supplement or replacement of the foregoing, in the transport refrigeration unit TRU, a resistance value of a second protective resistor in the heater is determined according to an operating voltage and a maximum allowable current of the transport refrigeration unit TRU, and a resistance-temperature characteristic of a first heating resistor.

As a supplement or replacement of the foregoing, in the transport refrigeration unit TRU, the resistance value R2 of the second protective resistor in the heater is determined according to the following formula:

$$R 2 = \frac{U}{{I}_{max}} - {R}_{1 min} ,$$

wherein U is the operating voltage of the transport refrigeration unit TRU, Iₘₐₓ is the maximum allowable current of the transport refrigeration unit TRU, and R₁ₘᵢₙ is a minimum resistance value of the first heating resistor.

According to a further aspect of the present application, there is provided a refrigeration system for a transport unit, the refrigeration system comprising the transport refrigeration unit TRU as previously described, wherein the transport refrigeration unit TRU is mounted on a side wall of the transport unit.

According to yet another aspect of the present application, there is provided a method of controlling a heater in a transport refrigeration unit TRU, the method comprising: setting a first heating resistor, the first heating resistor being a thermistor; setting a second protective resistor, the second protective resistor being connected in series with the first heating resistor and having a constant resistance value; and setting a temperature switch, the temperature switch being connected in parallel with the second protective resistor and enabling or bypassing the second protective resistor according to surface temperature of the first heating resistor.

As a supplement or replacement of the foregoing, in the method, the first heating resistor is a positive temperature coefficient PTC resistor.

### BRIEF DESCRIPTION OF THE DRAWINGS

The above and other purposes and advantages of the present application will be more complete and clear from the following detailed description in conjunction with the accompanying drawings, in which the same or similar elements are denoted by the same reference numerals.

FIG. 1 shows a schematic diagram of a structure of a heater according to an embodiment of the present application;

FIG. 2 shows a schematic diagram of a resistance-temperature characteristic of a PTC heater;

FIG. 3 shows a schematic diagram of a structure of a heater circuit according to an embodiment of the present application;

FIG. 4 shows a schematic diagram of the operating principle of a heater circuit according to an embodiment of the present application; and

FIG. 5 shows a method of controlling a heater in a transport refrigeration unit TRU according to an embodiment of the present application.

### DETAILED DESCRIPTION OF THE EMBODIMENTS

The present application is described more fully below with reference to the accompanying drawings, in which illustrative embodiments of the present application are illustrated. However, the present application may be implemented in different forms and should not be construed as limited to the embodiments presented herein. The presented embodiments are intended to make the disclosure herein comprehensive and complete, so as to more comprehensively convey the protection scope of the present application to those skilled in the art.

In this specification, terms such as “comprising” and “including” mean that in addition to units and steps that are directly and clearly stated in the specification and claims, the technical solution of the application does not exclude the presence of other units and steps that are not directly or clearly stated in the specification and claims.

Unless otherwise specified, terms such as “first” and “second” do not indicate the order of the units in terms of time, space, size, etc., but are merely used to distinguish the units.

In accordance with some embodiments of the present application, a heater includes, in addition to a heating resistor for heating, a protective resistor in series, which is used to protect the heater and prevent the current flowing through a heater circuit from exceeding the maximum allowable value. In addition, a temperature switch is connected in parallel at both ends of the protective resistor, and the temperature switch enables or bypasses the protective resistor according to surface temperature of the heating resistor, so as to effectively improves the working efficiency of the entire heater while avoiding the impulse current.

The specific embodiments of the present application are further described below with the aid of the accompanying drawings. It should be noted that some non-essential features or circuit elements are not shown in the accompanying drawings for the purpose of more clearly describing what is relevant to the present application. However, for those skilled in the art, such omissions do not create difficulties in the implementation of the technical solutions described in the specification of the present application.

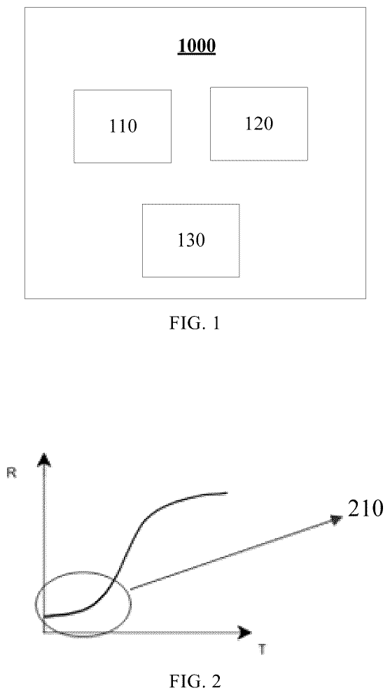

FIG. 1 shows a schematic diagram of a structure of a heater 1000 according to an embodiment of the present application. As shown in FIG. 1, the heater 1000 includes: a first heating resistor 110, a second protective resistor 120, and a temperature switch 130, wherein the first heating resistor 110 is a thermistor; the second protective resistor 120 is connected in series with the first heating resistor 110 and has a constant resistance value; and the temperature switch 130 is connected in parallel with the second protective resistor 120 and enables or bypasses the second protective resistor 120 according to surface temperature of the first heating resistor 110.

In the context of the present application, the term “heating resistor” refers to a resistor primarily used for heating functions. For example, when the heater 1000 is used in a transport refrigeration unit TRU, the heating resistor is primarily used to heat or defrost interior space of a transport unit (e.g., trailer, container, train wagon, etc.).

The first heating resistor is a thermistor (i.e., a resistor whose resistance value changes with temperature change). Thermistors are categorized into positive temperature coefficient (PTC) thermistors and negative temperature coefficient (NTC) thermistors according to their impedance-temperature characteristics. PTC is the acronym for Positive Temperature Coefficient, meaning positive temperature coefficient, and NTC is the acronym for Negative Temperature Coefficient, meaning negative temperature coefficient. In one embodiment, the first heating resistor is a positive temperature coefficient PTC resistor having a resistance value in the range of 5 ohms to 600 ohms.

In the context of the present application, the term “protective resistor” refers to a resistor having a protective function that can prevent the impulse current (current flowing through the protective resistor) generated when the heater is activated from exceeding the maximum current allowed by the transport refrigeration unit TRU.

In multiple embodiments of the present application, the second protective resistor 120 is connected in series with the first heating resistor 110 and has a constant resistance value. A resistor with a constant resistance value has surface temperature that is difficult to control during operation (e.g., when current flows through the resistor) unless additional complex control logic is added.

In the embodiment of FIG. 1, the temperature switch 130 is connected in parallel at both ends of the second protective resistor 120, which enables or bypasses the second protective resistor 120 according to the surface temperature of the first heating resistor 110. In one embodiment, the temperature switch 130 may comprise: a temperature probe and a switching unit, wherein the temperature probe is used to sense the surface temperature of the first heating resistor 110; the switching unit is used to keep the temperature switch 130 open when the surface temperature of the first heating resistor 110 is lower than a preset temperature threshold, and to close the temperature switch 130 when the surface temperature of the first heating resistor 110 is greater than or equal to the preset temperature threshold.

Here, the preset temperature threshold may be determined according to a resistance-temperature characteristic of the first heating resistor 110, for example set to be slightly below the curie point temperature. It will be appreciated by a person skilled in the art that, in addition to the resistance-temperature characteristic of the first heating resistor 110, the setting of the preset temperature threshold may also vary depending on the mounting position of the temperature probe.

In one or more embodiments of the present application, the above-described heater 1000 may be included in the transport refrigeration unit TRU or transport refrigeration units. In this embodiment, the resistance value of the second protective resistor 120 in the heater 1000 may be determined according to an operating voltage U and a maximum allowable current Imax of the transport refrigeration unit TRU, and a resistance-temperature characteristic of the first heating resistor 110.

For example, the resistance value R2 of the second protective resistor 120 is determined according to the following formula:

$$R 2 = \frac{U}{{I}_{max}} - {R}_{1 min} ,$$

wherein U is the operating voltage of the transport refrigeration unit TRU, Iₘₐₓ is the maximum allowable current of the transport refrigeration unit TRU, and R₁ₘᵢₙ is a minimum resistance value of the first heating resistor. As mentioned before, the first heating resistor may be a positive temperature coefficient PTC resistor having a minimum resistance value of a few ohms. During cold startup, the operating voltage of the transport refrigeration unit TRU may cause the current flowing through this first heating resistor to exceed the maximum allowable current, and the setting of the second protective resistor 120 can effectively avoid the above problem.

The transport refrigeration unit TRU may be integrated in a refrigeration system for a transport unit (e.g., a trailer, a container, a train wagon, etc.), wherein the transport refrigeration unit TRU is mounted on a side wall of the transport unit.

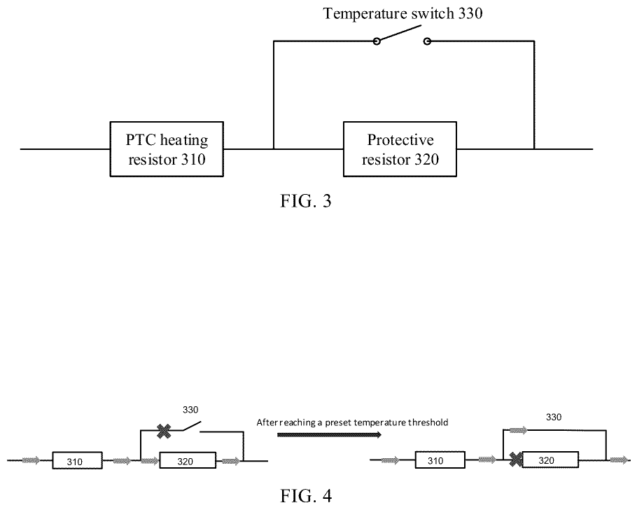

FIG. 3 shows a schematic diagram of a structure of a heater circuit according to an embodiment of the present application. As shown in FIG. 3, a PTC heating resistor 310 is connected in series with a protective resistor 320 (having a constant resistance value), and a temperature switch 330 is connected in parallel at both ends of the protective resistor 320. In the embodiment of FIG. 3, the temperature switch 330 is in a normally-open state and is controlled by an open-close control according to the temperature of the PTC heating resistor 310. Specifically, the temperature at which the temperature switch 330 is closed is slightly lower than the curie temperature point of the PTC heating resistor 310. When the electric heating function is on, the resistance value of the PTC heating resistor 310 is small, and the problem of excessive current can be solved by adding the protective resistor 320 having a constant resistance value. When the temperature of the PTC heating resistor 310 rises to a preset temperature threshold (e.g., curie temperature point), the temperature switch is closed and the protective resistor 320 is shorted. In this way, the working efficiency of the entire heater is effectively improved while avoiding the impulse current.

FIG. 4 shows a schematic diagram of the operating principle of a heater circuit according to an embodiment of the present application. As shown in FIG. 4, when the surface temperature of the PTC heating resistor 310 is low (e.g., in a cold state), the temperature switch 330 remains open, and the current flows directly through the PTC heating resistor 310 as well as the protective resistor 320. After the surface temperature of the PTC heating resistor 310 reaches a preset temperature threshold, the protective resistor 320 is bypassed or short-circuited due to the close of the temperature switch 330, i.e., the current will not flow through the protective resistor 320, further improving the working efficiency of the heater.

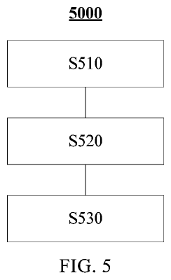

FIG. 5 shows a method 5000 of controlling a heater in a transport refrigeration unit TRU according to an embodiment of the present application. The method 5000 of controlling may comprise the following steps:

In step S510, setting a first heating resistor, the first heating resistor being a thermistor;

in step S520, setting a second protective resistor, the second protective resistor being connected in series with the first heating resistor and having a constant resistance value; and in step S530, setting a temperature switch, the temperature switch being connected in parallel with the second protective resistor and enabling or bypassing the second protective resistor according to surface temperature of the first heating resistor.

In one embodiment, the first heating resistor is a positive temperature coefficient PTC resistor. The above embodiments have at least the following advantages: (1) since the series electric heating circuit is controlled by the temperature switch, no additional controller signal is required and the heater circuit is adjusted only by the physical characteristic of the temperature switch; (2) enabling or bypassing the second protective resistor according to the surface temperature of the first heating resistor does not affect the heating power of the first heating resistor (e.g., the PTC resistor); (3) the heating is mainly done by the first heating resistor (e.g., the PTC resistor), with no risk of high temperature.

In summary, the heater of the embodiments of the present application includes, in addition to a heating resistor for heating, a protective resistor in series, which is used to protect the heater and prevent the current flowing through the heater circuit from exceeding the maximum allowable value. In addition, a temperature switch is connected in parallel at both ends of the protective resistor, and the temperature switch enables or bypasses the protective resistor according to surface temperature of the heating resistor, so as to effectively improves the working efficiency of the entire heater while avoiding the impulse current.

The above examples primarily illustrate the technical solutions of one or more embodiments of the present application. Although only some of these embodiments of the present application are described, it should be appreciated by those of ordinary skill in the art that the present application may be implemented in many other forms without departing from the spirit and scope thereof. Accordingly, the examples and embodiments presented are to be regarded as illustrative and not restrictive, and various modifications and substitutions may be covered by the application without departing from the spirit and scope of the application as defined by the appended claims.

1. A heater, characterized by comprising:
a first heating resistor, the first heating resistor being a thermistor;
a second protective resistor connected in series with the first heating resistor, wherein the second protective resistor has a constant resistance value; and
a temperature switch connected in parallel with the second protective resistor, wherein the temperature switch enables or bypasses the second protective resistor according to surface temperature of the first heating resistor.

2. The heater of claim 1, wherein the first heating resistor is a positive temperature coefficient PTC resistor.

3. The heater of claim 2, wherein the temperature switch comprises:
a temperature probe for sensing the surface temperature of the first heating resistor; and
a switching unit for keeping the temperature switch open when the surface temperature of the first heating resistor is lower than a preset temperature threshold, and causing the temperature switch to close when the surface temperature of the first heating resistor is greater than or equal to the preset temperature threshold.

4. The heater of claim 3, wherein the preset temperature threshold is determined according to a resistance-temperature characteristic of the first heating resistor.

5. A transport refrigeration unit TRU, characterized by comprising a heater as claimed claim 1.

6. The transport refrigeration unit TRU of claim 5, wherein a resistance value of a second protective resistor in the heater is determined according to an operating voltage and a maximum allowable current of the transport refrigeration unit TRU, and a resistance-temperature characteristic of a first heating resistor.

7. The transport refrigeration unit TRU of claim 6, wherein the resistance value R2 of the second protective resistor in the heater is determined according to the following formula:
$$R 2 = \frac{U}{{I}_{max}} - {R}_{1 min} ,$$
wherein U is the operating voltage of the transport refrigeration unit TRU, Iₘₐₓ is the maximum allowable current of the transport refrigeration unit TRU, and R₁ₘᵢₙ is a minimum resistance value of the first heating resistor.

8. A refrigeration system for a transport unit, characterized by comprising a transport refrigeration unit TRU as claimed in claim 5, wherein the transport refrigeration unit TRU is mounted on a side wall of the transport unit.

9. A method of controlling a heater in a transport refrigeration unit TRU, characterized by comprising:
setting a first heating resistor, the first heating resistor being a thermistor;
setting a second protective resistor, the second protective resistor being connected in series with the first heating resistor and having a constant resistance value; and
setting a temperature switch, the temperature switch being connected in parallel with the second protective resistor and enabling or bypassing the second protective resistor according to surface temperature of the first heating resistor.

10. The method of claim 9, wherein the first heating resistor is a positive temperature coefficient PTC resistor.
